(19) United States
(12) Patent Application Publication
(10) Pub. No.: US 2005/0264653 A1
(43) Pub. Date: Dec. 1, 2005

(54) Portable electronic device with adjustable image capture orientation and method therefore

(76) Inventors: James A. Starkweather, Boca Raton, FL (US); David G. Southeard, St. Albans (GB)

Correspondence Address: Randi L. Karpinia;Motorola, Inc., Law Department, 8000 West Sunrise Boulevard, Fort Lauderdale, FL, 33322, US

(21) Appl. No.: 10/855,020

(22) Filed: May 27, 2004

(51) Int. Cl. H04N 5/228; H04N 5/222

(52) U.S. Cl. 348/208.3; 348/333.05

(57) ABSTRACT

A portable electronic device (100,200) includes an image capture means (245) for capturing an image, wherein the image capture means (245) has an orientation; and an image manager (255) coupled to the image capture means (245) for modifying the image using the orientation.

### BACKGROUND OF THE INVENTION

1. Field of the Invention

The present invention is generally related to portable electronic devices; and more particularly to a portable electronic device with image capture and transmission capability.

2. Description of the Related Art

Cellular telephones, messaging devices, PDAs (Personal Digital Assistants) and other portable electronic devices having communication capability have become fixtures of everyday life over the last several years. As they evolve, prices continue to fall while the devices' capabilities have expanded.

Such expanded capabilities include connectivity to and incorporation of various imaging devices such as still-imaging and video cameras. For example, there are still-image and video camera accessories that can be connected to a cellular telephone. Such accessories allow the device user to take pictures, view them on the display of cellular telephone, and send them to another cellular telephone which supports the same standard. Some devices further provide capability to send photographs taken by other electronic devices such as personal computers and the like. Further, some device manufacturers are offering portable electronic devices with built-in cameras.

Portable electronic devices with image capture capability can be used for communicating an image of the device user to a remote party receiving the communication. For example, when participating within a video telephone call, one participant can transmit a video image of himself/herself during the call. Portable electronic devices with image capture capability can also be used to capture images surrounding the device for utilization within applications of the device and/or to communicate to a remote party. These various utilizations typically require different positioning of the image capture device for optimum usage.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 illustrates a portable electronic device.

FIG. 2 is an electronic block diagram of the portable electronic device of FIG. 1.

FIG. 3 is a flowchart illustrating one embodiment of the operation of the portable electronic device of FIGS. 1 and 2.

### DETAILED DESCRIPTION

The present invention relates to the multiple uses for image capture devices and displays within portable electronic devices. One exemplary use is the usage of video displays and camera rotation while in a video telephony call. To best accommodate the usage of the video displays, the present invention provides a method for varying a display image orientation dependent upon the image source position. For example, while a camera is pointed toward a device user during a video communication, the normal image orientation is QCIF for received image and quarter-QCIF for viewfinder, and while the camera is pointed away from the device user, the normal image orientation is QCIF for viewfinder and quarter-QCIF for received image. This orientation is based on the premise that during face to face video calling the device user is most likely interested in seeing the received image, but when the camera is rotated away from the device user toward some object, the device user is most likely interested in seeing the image being captured and transmitted to the remote recipient device. In either normal image orientation, the user can override the default orientation and re-arrange QCIF & quarter-QCIF images.

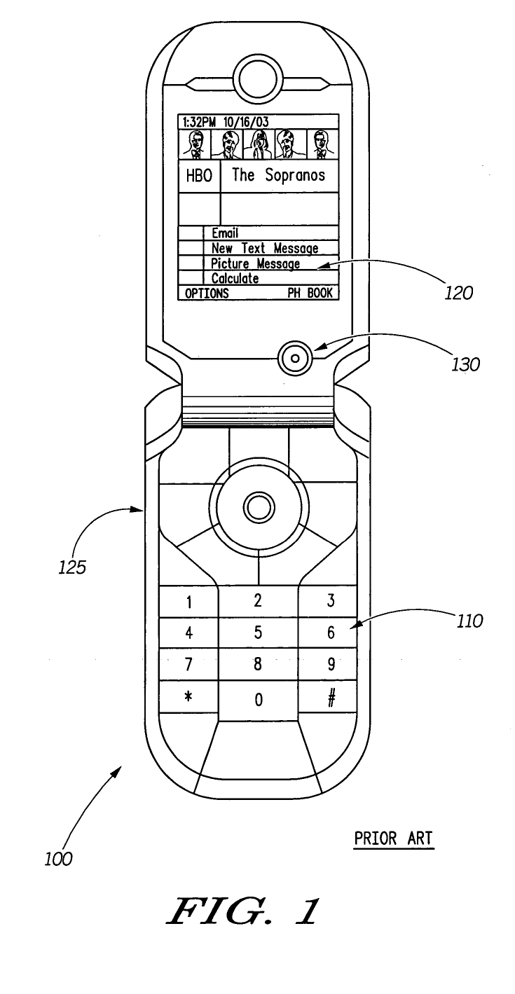

Referring to FIG. 1, a portable electronic device 100 is illustrated. The portable electronic device 100, for example, can be a cellular telephone (as illustrated), a cordless telephone, a wired landline telephone, a personal communicator, or an equivalent. Similarly, the portable electronic device 100 can be a PDA (personal digital assistant), a portable personal computer, or an equivalent. In the following description, the term “portable electronic device” refers to any of the devices mentioned above or an equivalent.

The portable electronic device 100 preferably includes a user interface (such as a keypad 110 and a display 120) and a housing 125. The keypad 110 allows the user of the portable electronic device 100 to enter data such as telephone numbers and text memos and to perform various functions within the portable electronic device 100.

The display 120 displays data such as one or more communication messages, telephone numbers, and caller identifications. The display 120 further can display graphics such as screen savers, wallpaper, gaming applications, and the like. Similarly, the display 120 can display still image and video images received by the portable electronic device, programmed into the portable electronic device 100, or captured by the portable electronic device 100 itself. The display 120 can include one display portion for displaying a single image, or alternatively, can include a plurality of display portions for displaying multiple images (i.e. picture in picture), multiple views of the same image, or a combination of displayed data, images, graphics, and the like. It will be appreciated by those of ordinary skill in the art that the display 120 can be a liquid crystal display, a cathode ray tube display, one or more organic light emitting diodes, one or more LEDs, a plasma display, or an equivalent.

The housing 125 encloses the various elements of the portable electronic device 100 and provides mechanical support for the portable electronic device 100. The housing 125, for example can be a flip assembly housing (as illustrated) consisting of two or more housing portions. One housing portion rotates relative to the other housing portion in a plane perpendicular to the plane of the other housing portion. As an example, a communication device such as a radiotelephone can comprise two planar elements coupled by a hinge. When the radiotelephone is not in use, the two planar elements are closed and lie in parallel. When the radiotelephone is in use, the two planar elements are opened in relation to each other, exposing such elements as a key pad, display, microphone and/or speaker. Alternatively, the housing 125 can comprise a single piece housing, a circularly rotational housing, or an equivalent.

Preferably, the portable electronic device 100 further includes an image capture source 130. The image capture source 130, for example, can be one or more digital video cameras, digital still cameras, an image or image sequence stored in memory, or an equivalent, and/or any combination thereof.

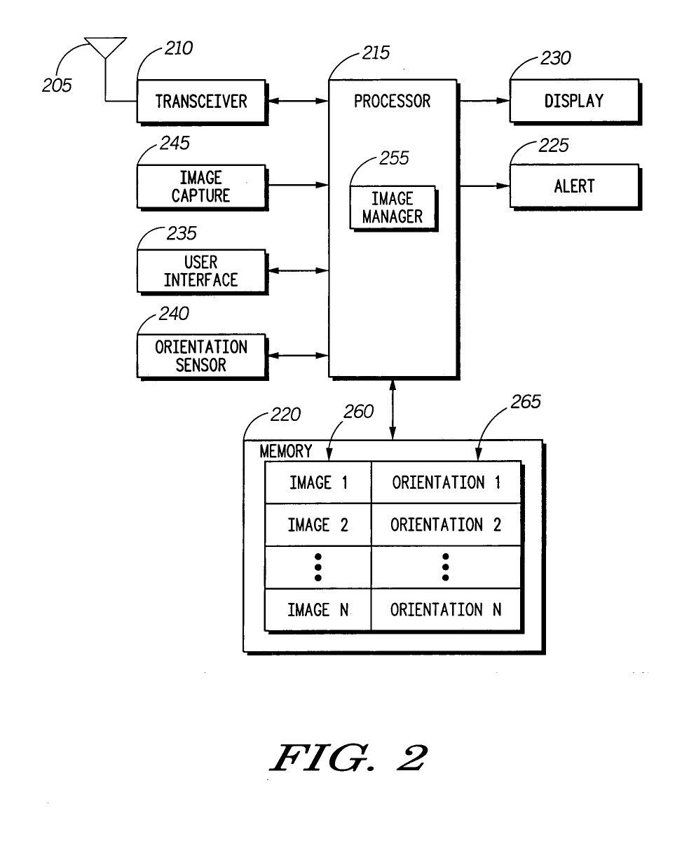

FIG. 2 is an electronic block diagram of one embodiment of the portable electronic device 100 of FIG. 1. Specifically, FIG. 2 illustrates a communication device 200. The communication device 200, by way of example only, can be embodied in a cellular radiotelephone having a conventional cellular radio transceiver circuitry, as is known in the art, and will not be presented here for simplicity. The invention is alternatively applied to other communication devices such as, for example, messaging devices, personal digital assistants and personal computers with communication capability, mobile radio handsets, cordless radiotelephone and the like. It will be appreciated by those of ordinary skill in the art that the communication device 200 is illustrative of one embodiment of the portable electronic device 100 and that alternative embodiments such as fixed network devices or cable broadcast devices can be used in accordance with the present invention.

As illustrated, the communication device 200 includes an antenna 205, a transceiver 210, a processor 215, a memory 220, an alert 225, a display 230, a user interface 235, an image sensor 240, and an image capture means 245.

The antenna 205 intercepts transmitted signals such as a message, data, or a voice call from one or more communication systems and transmits signals to the one or more communication systems. It will be appreciated by those of ordinary skill in the art that one or more of the communication systems, in accordance with the present invention, can function utilizing any wireless radio frequency (RF) channel, for example, a two-way messaging channel, a mobile cellular telephone channel, or a mobile radio channel. Similarly, it will be appreciated by one of ordinary skill in the art that one or more of the communication systems can function utilizing other types of wireless communication channels such as infrared channels and/or Bluetooth channels. Similarly, it will be appreciated by one of ordinary skill in the art that one or more of the communication systems can function utilizing a wireline communication channel such as a local area network (LAN) or a wide area network (WAN) or a combination of both. The LAN, for example, can employ any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures. The WAN, for example, can use a physical network media such as X.25, Frame Relay, ISDN, Modem dial-up or other media. In the following description, the term “communication system” refers to any of the communication systems mentioned above or an equivalent. Further, in the following description, the term “communication device” refers to any device operating within the communication systems mentioned herein or an equivalent.

The antenna 205 is coupled to the transceiver 210, which employs conventional demodulation techniques for receiving the communication signals. The transceiver 210 is coupled to the processor 215 and is responsive to commands from the processor 215. When the transceiver 210 receives a command from the processor 215, the transceiver 210 sends a signal via the antenna 205 to one or more of the communication systems. In an alternative embodiment (not shown), the communication device 200 includes a receive antenna and a receiver for receiving signals from one or more of the communication systems and a transmit antenna and a transmitter for transmitting signals to one or more of the communication systems. It will be appreciated by one of ordinary skill in the art that other similar electronic block diagrams of the same or alternate type can be utilized for the communication device 200.

Coupled to the transceiver 210, is the processor 215 utilizing conventional signal-processing techniques for processing received messages. It will be appreciated by one of ordinary skill in the art that additional processors can be utilized as required to handle the processing requirements of the processor 215. The processor 215 decodes an identification in the demodulated data of a received message, compares the decoded identification with one or more identifications stored in the memory 220, and when a match is detected, proceeds to process the remaining portion of the received message. The one or more identifications, for example, can be a unique selective call address assigned within a wireless communication system, an electronic mail address, an IP (internet protocol) address or any other similar identification.

In accordance with the present invention, the processor 215 includes an image manager 255 for manages the receipt, processing, transmitting, storing, and displaying of various images. The image manager 255 receives inputs from the transceiver 210, other portions of the processor 215, the orientation sensor 240, the image capture means 245, and the user interface 235. The image manager 255 further stores images within the memory 220. The image manager 255 is adapted to determine an orientation of a desired input using the various received inputs and displaying the image and associated orientation on the display 230. It will be appreciated by those of ordinary skill in the art that the image manager 255 can be hard coded or programmed into the communication device 200 during manufacturing, can be programmed over-the-air upon customer subscription, or can be a downloadable application. It will be appreciated that other programming methods can be utilized for programming the image manager 255 into the communication device 200. It will be further appreciated by one of ordinary skill in the art that the image manager 255 can be hardware circuitry within the portable communication device 200. In accordance with the present invention, the image manager 255 can be contained within the processor 215 as illustrated, or alternatively can be an individual monitor block operatively coupled to the processor 215 (not shown).

To perform the necessary functions of the communication device 200, the processor 215 is coupled to the memory 220, which preferably includes a random access memory (RAM), a read-only memory (ROM), an electrically erasable programmable read-only memory (EEPROM), and flash memory. The memory 220, for example, includes memory locations for the storage of one or more received or transmitted messages, one or more software applications, one or more image data, and the like. The flash memory is especially useful for easy and fast information storage of the images taken by the image capture means 245 such as an integrated camera function. It will be appreciated by those of ordinary skill in the art that the memory 220 can be integrated within the communication device 200, or alternatively, can be at least partially contained within an external memory such as a memory storage device. The memory storage device, for example, can be a subscriber identification module (SIM) card. A SIM card is an electronic device typically including a microprocessor unit and a memory suitable for encapsulating within a small flexible plastic card. The SIM card additionally includes some form of interface for communicating with the communication device 200. The SIM card can be used to transfer a variety of information from/to the communication device 200 and/or any other compatible device. The memory 220 preferably stores one or more images 260 and one or more associated image orientation data 265.

Upon receipt and processing of a message or a call, the processor 215 preferably generates a command signal to the alert 225 as a notification that the message has been received and stored or alternatively that a call is waiting for a response. The alert 225 similarly can be utilized for other alerting notifications such as an alarm clock, expiration of a timer, or the memory 220 being at its memory storage limitations. Similarly, the alert 225 can be utilized for alerting a user of a request for a user input. The alert 225 can include a speaker (not shown) with associated speaker drive circuitry capable of playing melodies and other audible alerts, a vibrator (not shown) with associated vibrator drive circuitry capable of producing a physical vibration, or one or more light emitting diodes (LEDs) (not shown) with associated LED drive circuitry capable of producing a visual alert. It will be appreciated by one of ordinary skill in the art that other similar alerting means as well as any combination of the audible, vibratory, and visual alert outputs herein described can be used for the alert 225.

Upon receipt and processing of a message or a received call, the processor 215 preferably also generates a command signal to the display 230 to generate a visual notification. Similarly, the display 230 can be utilized as a means for providing a visual image to the user. For example, one or more still images or video images can be displayed on the display 230 for viewing by the user.

Preferably, the user interface 235 is coupled to the processor 215. The user interface 235 can include a keypad such as one or more buttons used to generate a button press or a series of button presses. The user interface 235 can also include a voice response system or other similar method of receiving a manual input initiated by the device user. The processor 215, in response to receiving a user input via the user interface 235 performs commands as required. For example, the user interface 235 can be utilized for performing functions related to the messages stored in the memory 220 such as reading, replying, or deleting one or more stored email messages. The user interface 235 further can be used to perform various functions and make various operational choices for functioning of the communication device 200. For example, the user interface 235 can be used to provide inputs to the image manager 255 for image capture by the imaging capture means 245.

The communication device 200, as illustrated, includes the image capture means 245 coupled to the processor 215. It will be appreciated by one of ordinary skill in the art that the image capture means 245 can be integrated within the communication device 200 or alternatively externally coupled to the communication device 200. The image capture means 245, for example, can be a camera including the necessary circuitry for providing camera functionality to the communication device 200. Preferably, the image capture means 245 includes functionality of a digital camera. For example, the image capture means 245 can include software and circuitry for the calculations that are made each time a picture is taken. The image capture means 245 provides functionality to preview, capture, compress, filter, store, transfer, and display the image. Typically, the image capture means 245 includes a microprocessor programmed to perform these calculations and other various functions. The Paragon built-in camera is designed to operate in two positions. The image capture means 245 can be rotatably changed to provide various positions for capturing images. For example, a first position can be aimed toward the user for capturing an image of the device user to be transmitted to a remote party. A second position is achieved by rotating the camera to aim away form the user to capture pictures of the device surroundings for transmission to a remote party while still viewing the remote party on the display 230.

The communication device 200, as illustrated, includes the orientation sensor 240 operatively coupled to the processor 215 and specifically operatively coupled to the image manager 255 within the processor 215. The orientation sensor 240 utilizes technologies well known in the art to sense the orientation of the communication device 200 and further the orientation of the one or more image capture sources with respect to the communication device 200.

In accordance with the present invention, the image manager 255 is adapted to receive one or more images from the image capture sources 245 and/or one or more images from the memory 220, the orientation information from the orientation sensor 240, and one or more user inputs from the user interface 235, and determine how each of the images will be displayed on the display 230. To optimize the flexibility of the display 230, the image manager 255 is adapted to determine the displayed image orientation dependent upon the position of either or both the communication device 200 and/or the image capture means 245. For example, while in a video telephony call, two video images can be rendered on-screen, a larger video image, and below it, a smaller video image. The larger image can be a received video image (from the remote device), while the smaller image can be a local, viewfinder image. Both images can be displayed simultaneously, next to each other. This orientation is based on the premise that during face to face video calling the user is most likely interested in seeing the received image, but when the camera is rotated away from the user toward some object, the user is most likely interested in seeing the image being captured and transmitted to a remote communication device.

In one embodiment, the image capture means 245 comprises more than one image capture device. For example, the image capture means 245 can include two cameras. (i.e.: video graphics array camera facing to the user, and a higher resolution camera facing away from user). In this embodiment, the image manager 255 includes an input of which image capture means is being utilized in determining how to display and/or transmit the captured image.

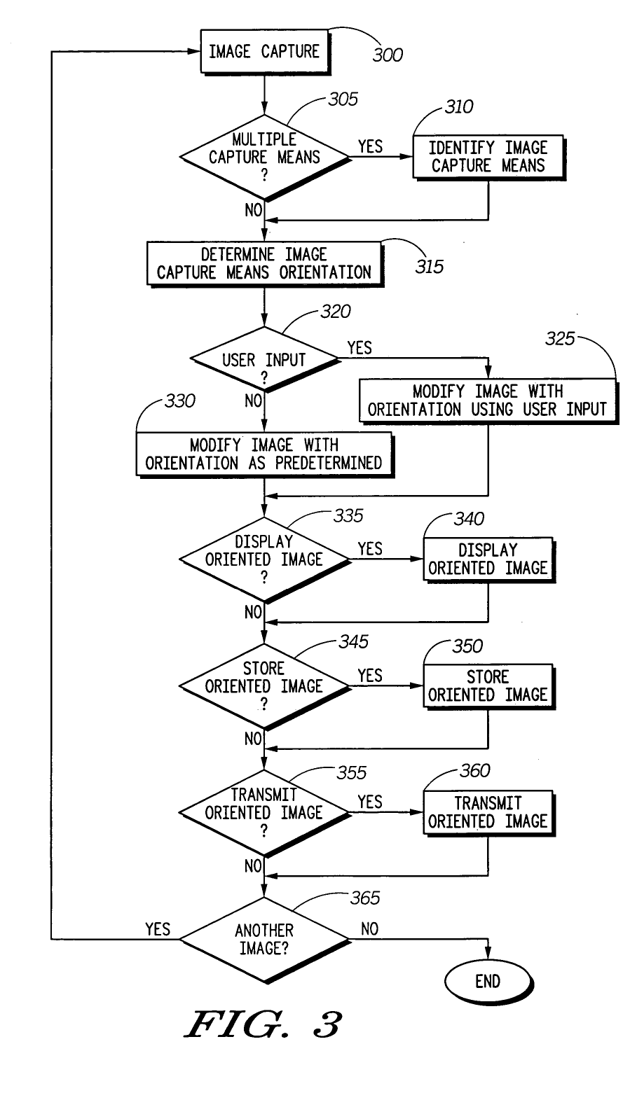

FIG. 3 is a flowchart illustrating one embodiment of the operation of the portable electronic device (100,200) of FIGS. 1 and 2. Specifically, the operation illustrates one embodiment of the operation of the image manager 255. As illustrated in FIG. 3, the operation begins with Step 300 in which an image is captured by the device. Next, in Step 305, the operation determines whether or not the portable electronic device (100,200) includes more than one image capture means 245. When the portable electronic device (100,200) includes more than one image capture means 245, the operation continues with Step 310 in which the image manager 255 identifies the particular image capture means used to capture the current image.

Next and when the portable electronic device (100,200) contains only one image capture means 245, in Step 315, the operation determines the orientation of the identified image capture means 245. For example, the orientation sensor 240 can supply the image manager 255 with the orientation of the image capture means 245, or alternatively the orientation of the portable electronic device (100,200) itself. Alternatively, the image manager 255 can determine the orientation of the image capture means 245 based upon an operation or application being executed. It will be appreciated by those of ordinary skill in the art that other methods as are well known in the art can be used to determine the orientation of the image capture means 245. The orientation, for example, can include the direction for which the image capture means 245 is pointing, an angle of tilt of the image capture means 245, a position of the image capture means 245, and the like.

Next, in Step 320, the operation determines whether or not a user input associated with the captured image has been received via the user interface 235. For example, the image manager 255 can query a device user using the display 230 or the alert 225 requesting acceptance of the orientation. A user input to the user interface 235 can indicate acceptance or rejection of the current orientation. In one embodiment, (not shown) the image is displayed on the display 230 with the orientation to assist the user in determining if the orientation is acceptable. When a user input has been received, the operation continues with Step 325 in which the image is associated with the orientation using the user input. In other words, the user input can identify the size, shape, position for display, of the captured image. When no user input has been received in Step 320, the operation continues to Step 330 in which the capture image is associated with the orientation using a predetermined set of parameters and/or instructions. For example, the predetermined set of parameters and/or instructions can be a pre-programmed set of parameters or instructions. Association with the orientation can include modifying the image based on the orientation, or alternatively, identifying the orientation with the image for later image processing.

Upon completion of Step 330 or Step 325, the operation continues to Step 335 in which the image manager 255 determines whether or not to display the oriented image. When displaying of the oriented image is required/desired, the operation continues to Step 340 and the orientated image (i.e. the captured image along with the appropriate orientation) is displayed on the display 230.

Next, and/or when no display is desired in Step 330, the operation continues to Step 345 in which the image manager 255 determines whether or not to store the oriented image in the memory 220. For example, the device user may desire to store the captured image with the appropriate orientation in the memory 220 for later retrieval and/or utilization. When it is required/desired to store the image in Step 345, the operation continues to Step 350 and the image is stored along with the associated orientation.

Next, and when the image is not required/desired to be stored in Step 335, the operation continues to Step 355 in the operation determines whether or not it is required/desired to transmit the oriented image. When transmission of the oriented image is required, desired, the operation continues to Step 360 in which the oriented image is transmitted via a communication system to another device.

Next, and when transmission of the oriented image is not required/desired in Step 355, the operation continues to Step 360 in which the image manager 255 determines whether or not another image is awaiting capture and processing. When no other image is awaiting capture and processing, the operation ends. When another image is awaiting capture and processing, the operation cycles back to Step 300 and the image is captured.

The device and method of operation as recited herein allows a device user to capture images at a variety of positions and orientations and process them for display, storage, and/or transmission within a portable electronic device. The user thus doesn't need to hold the image capture means or the communication device in any specific orientation to obtain a multitude of desired image results.

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

1. A method for image capture within a portable electronic device, the method comprising the steps of:
capturing an image using an image capture means;
determining an orientation of the image capture means; and
modifying the image using the orientation.

2. A method for image capture as recited in claim 1, wherein the portable electronic device comprises more than one image capture means, the method further comprising the step of:
identifying an image capture means used to capture the image prior to the determining step.

3. A method of image capture as recited in claim 1, further comprising prior to the modifying step, the steps of:
receiving a user input associated with the captured image, and
wherein the modifying step includes modifying the image using the user input along with the orientation.

4. A method of image capture as recited in claim 1, wherein the portable electronic device includes a display for displaying images, the method further comprising the step of:
displaying the modified image.

5. A method of image capture as recited in claim 1, wherein the portable electronic device includes a memory, the method further comprising the step of:
storing the modified image in the memory.

6. A method of image capture as recited in claim 1, wherein the portable electronic device includes a transmitter for communication with one or more recipient devices, the method further comprising the step of:
transmitting the modified image to the one or more recipient devices.

7. A method for image capture within a portable electronic device, the method comprising the steps of:
capturing a first image using an image capture means;
determining a first orientation of the image capture means;
modifying the first image using the first orientation;
capturing a second image using the image capture means;
determining a second orientation of the image capture means; and
modifying the second image using the second orientation.

8. A method for image capture as recited in claim 7, wherein the portable electronic device includes a display having a first portion and a second portion, the method further comprising the steps of:
displaying the modified first image on the first portion of the display; and
displaying the modified second image on the second portion of the display.

9. A method for image capture as recited in claim 7, wherein the portable electronic device includes a display, and a transmitter for communicating with one or more recipient devices, the method further comprising the steps of:
displaying the modified first image on the display; and
transmitting the modified second image to the one or more recipient devices.

10. A method for image capture within a portable electronic device, wherein the portable electronic device includes more than one image capture means, the method comprising the steps of:
capturing a first image using a first image capture means;
determining a first orientation of the first image capture means;
modifying the first image using the first orientation;
capturing a second image using a second image capture means;
determining a second orientation of the second image capture means; and
modifying the second image using the second orientation.

11. A method for image capture as recited in claim 10, wherein the portable electronic device includes a display having a first portion and a second portion, the method further comprising the steps of:
displaying the modified first image on the first portion of the display; and
displaying the modified second image on the second portion of the display.

12. A method for image capture as recited in claim 10, wherein the portable electronic device includes a display, and a transmitter for communicating with one or more recipient devices, the method further comprising the steps of:
displaying the modified first image on the display; and
transmitting the modified second image to the one or more recipient devices.

13. A portable electronic device comprising:
an image capture means for capturing an image, wherein the image capture means has an orientation; and
an image manager coupled to the image capture means for modifying the image using the orientation.

14. A portable electronic device as recited in claim 13, further comprising:
a user interface coupled to the image manager for receiving a user input associated with the captured image, and
wherein the image manager uses the user input along with the orientation to modify the image.

15. A portable electronic device as recited in claim 13, further comprising:
a display coupled to the image manager for displaying the modified image.

16. A portable electronic device as recited in claim 13, further comprising:
a memory coupled to the image manager for storing the modified image.

17. A portable electronic device as recited in claim 13, further comprising:
a transmitter coupled to the image manager for transmitting the modified image to one or more recipient devices.

18. A portable electronic device comprising:
an image capture means having:
a first orientation for capturing a first image, and
a second orientation for capturing a second image;
an image manager coupled to the image capture means for:
modifying the first image using the first orientation, and
modifying the second image using the second orientation.

19. A portable electronic device as recited in claim 18, further comprising:
a display coupled to the image manager, the display having:
a first portion for displaying the modified first image, and
a second portion for displaying the modified second image.

20. A portable electronic device as recited in claim 18, further comprising:
a display coupled to the image manager for displaying the modified first image; and
a transmitter coupled to the image manager for transmitting the modified second image to one or more recipient devices.

21. A portable electronic device comprising:
a first image capture means having a first orientation for capturing a first image;
a second image capture means having a second orientation for capturing a second image; and
an image manager coupled to the first image capture means and the second image capture means for modifying the first image using the first orientation and for modifying the second image using the second orientation.

22. A portable electronic device as recited in claim 21, further comprising:
a display coupled to the image manager, the display having:
a first portion for displaying the modified first image, and
a second portion for displaying the modified second image.

23. A portable electronic device as recited in claim 21, further comprising:
a display coupled to the image manager for displaying the modified first image; and
a transmitter coupled to the image manager for transmitting the modified second image to one or more recipient devices.
